(19) United States
(12) Patent Application Publication
(10) Pub. No.: US 2023/0102000 A1
(43) Pub. Date: Mar. 30, 2023

(54) TIME-SERIES PATTERN EXPLANATORY INFORMATION GENERATING APPARATUS

(71) Applicant: Hitachi, Ltd., Tokyo (JP)

(72) Inventors: Shinichi TSUNO, Tokyo (JP); Yoshiyuki TAJIMA, Tokyo (JP)

(21) Appl. No.: 17/793,803

(22) PCT Filed: Jan. 15, 2021
(86) PCT No.: PCT/JP2021/001368

§ 371 Date: Jul. 19, 2022

(30) Foreign Application Priority Data
Feb. 3, 2020 (JP) 2020-016215

(51) Int. Cl. G06N 5/022

(52) U.S. Cl. CPC G06N 5/022

(57) ABSTRACT

The time-series pattern explanatory information generating apparatus includes a prediction model learning unit configured to learn time-series data acquired from a monitored system in a neural network to construct a prediction model. A candidate sequence pattern generating unit is configured to use the prediction model to extract candidate sequence patterns included in time-series data and indicating a characteristic change. A sequence pattern generating unit calculates a dissimilarity among the candidate sequence patterns to classify the candidate sequence patterns, and output a representative candidate sequence pattern included in each classification as a sequence pattern of time-series data; and a time-series data analyzing unit calculates a feature from an arbitrary sequence pattern extracted from time-series data obtained from the monitored system, draws a comparison with a change detection model storing a feature, in advance, from a normal-time sequence pattern, and outputs an analysis result as to whether the monitored system is normal.

### TECHNICAL FIELD

The present invention relates to a time-series pattern explanatory information generating apparatus that generates information for explaining a variation in time-series data collected from a sensor or the like installed in a monitored system.

### BACKGROUND ART

A plant in a power generation field or an industrial field may become in a non-operating state in the case of a failure of facilities or equipment, resulting in a revenue decrease. Therefore, it is necessary to monitor the state of the plant to notice an abnormality or a sign thereof. In the state monitoring, data such as temperature and pressure obtained from sensors installed in the plant is collected in time series. The collected data is displayed, checked, and analyzed.

There has been proposed a technique of generating a text explaining a variation in time-series numerical data by using a neural network language model. The time-series numerical data includes a sequence of numerical values changing with the lapse of time (for example, stock price, vital data such as electrocardiogram data and blood pressure data, weather data such as temperature and humidity, traffic data such as traffic volume and a passenger figure, and the like).

For example, PTL 1 below describes a text generating apparatus that generates text data explaining a variation in time-series numerical data including a numerical sequence associated with a lapse of time, the text generating apparatus including: a learning unit configured to, using replacement text data and time-series numerical data as training data, train a language model to output a piece of replacement text data when a piece of time-series numerical data is input; a generating unit configured to generate a new piece of replacement text data explaining a new piece of time-series numerical data by inputting the new piece of time-series numerical data to the language model trained by the learning unit and using output from the language model; and a replacement unit configured to replace a predetermined character string included in the new piece of replacement text data with a numerical value related to the new piece of time-series numerical data according to a predetermined rule.

### CITATION LIST

### Patent Literature

PTL 1: JP 2019-046158 A

### SUMMARY OF INVENTION

### Technical Problem

PTL 1 presents a method of generating a text for time-series numerical data, in which a period of one business day and a period of seven business days are set in advance as an input data section of the time-series numerical data. However, a method of specifying any other period is not disclosed. It is not possible to respond to a user's request to generate a text for a long period or to generate a text for a short period.

In addition, it is difficult to determine a length of the period for enormous (long-term) data for which a text is to be generated. Furthermore, individually selecting the period from the data is very costly.

Therefore, an object of the present invention is to provide a time-series pattern explanatory information generating apparatus that identifies a type of products from time-series data and generates information for explaining the time-series data for a user-desired period.

### Solution to Problem

A preferred example of a time-series pattern explanatory information generating apparatus of the present invention includes: a prediction model learning unit configured to, when time-series data acquired from a monitored system is input, learn the time-series data in a neural network to construct a prediction model; a candidate sequence pattern generating unit configured to use the prediction model to extract candidate sequence patterns each of which is local sequence data included in the time-series data, the local sequence data indicating a characteristic change having a high appearance probability; a sequence pattern generating unit configured to calculate a dissimilarity among the extracted candidate sequence patterns to classify the extracted candidate sequence patterns, and output a representative candidate sequence pattern included in each classification as a sequence pattern of the time-series data; and a time-series data analyzing unit configured to designate a sequence pattern that is freely selected from sequence patterns extracted from time-series data obtained from the monitored system, calculate a feature from the designated sequence pattern, draw a comparison with a change detection model storing a feature calculated, in advance, from a normal-time sequence pattern, and output an analysis result as to whether the monitored system is normal.

As another aspect of the present invention, in the time-series pattern explanatory information generating apparatus, the time-series data analyzing unit is configured to calculate a feature from a sequence pattern extracted from time-series data to be analyzed, draw a comparison with the change detection model, and determine whether the monitored system is normal. The time-series pattern explanatory information generating apparatus further includes an explanatory information generating unit configured to, when the monitored system is determined to be abnormal, search a past history to read a piece of supplementary information formerly recorded by a user, and display, on an explanatory information display screen, a graph of data contributing to abnormality, explanatory information of an analysis result, and the piece of the supplementary information.

### Advantageous Effects of Invention

The time-series pattern explanatory information generating apparatus according to the present invention can identify a type of products from time-series data and generate information for explaining the time-series data for a user-desired period.

### BRIEF DESCRIPTION OF DRAWINGS

FIG. 1 is a configuration diagram of a time-series pattern explanatory information generating apparatus according to a first embodiment.

FIG. 2 is an example of a graph of temperature change of a metalworking manufacturer's system.

FIG. 3 is a diagram illustrating an example of time-series data in a data record format where output values of sensors are associated with each time.

FIG. 4 is a flowchart illustrating an example of prediction model f learning processing.

FIG. 5 is a diagram illustrating an example of an intermediate data table for generating candidate sequence patterns.

FIG. 6 is a flowchart of candidate sequence pattern extraction processing.

FIG. 7 is a diagram illustrating a table summarizing parameters used in functional units of the first embodiment and descriptions thereof.

FIG. 8 is a flowchart of sequence pattern generation processing.

FIG. 9 is a diagram illustrating a data table in which a sequence pattern ID, a candidate sequence pattern ID, and a representative candidate sequence pattern ID are associated with each other for management.

FIG. 10 is a flowchart of processing of estimating where a designated sequence pattern is located on time-series data to be processed.

FIG. 11 is a diagram illustrating an example of an output data table of an estimation labeling result.

FIG. 12 is a flowchart of processing of learning, in a change detection model, features of sequence patterns of time-series data when a monitored system is normal.

FIG. 13 is a flowchart of time-series data analysis processing in accordance with an analysis request for time-series data from the monitored system.

FIG. 14 is a diagram illustrating an example of a history information table in which a time-series data analysis result is recorded, and an example of a supplementary information table in which a comment input by a user is recorded.

FIG. 15 is an image diagram illustrating time-series data input to a sequence pattern proposal presentation unit, parameters (maximum number V of candidate levels of a threshold value θ and number N of sequence patterns), and sequence pattern proposals and sequence patterns to be output.

FIG. 16 is a diagram illustrating an example of an explanatory information display screen output to a user terminal on the basis of an analysis result and past history search.

### DESCRIPTION OF EMBODIMENTS

Hereinafter, an example of a time-series pattern explanatory information generating apparatus of the present invention will be described with reference to the drawings.

### First Embodiment

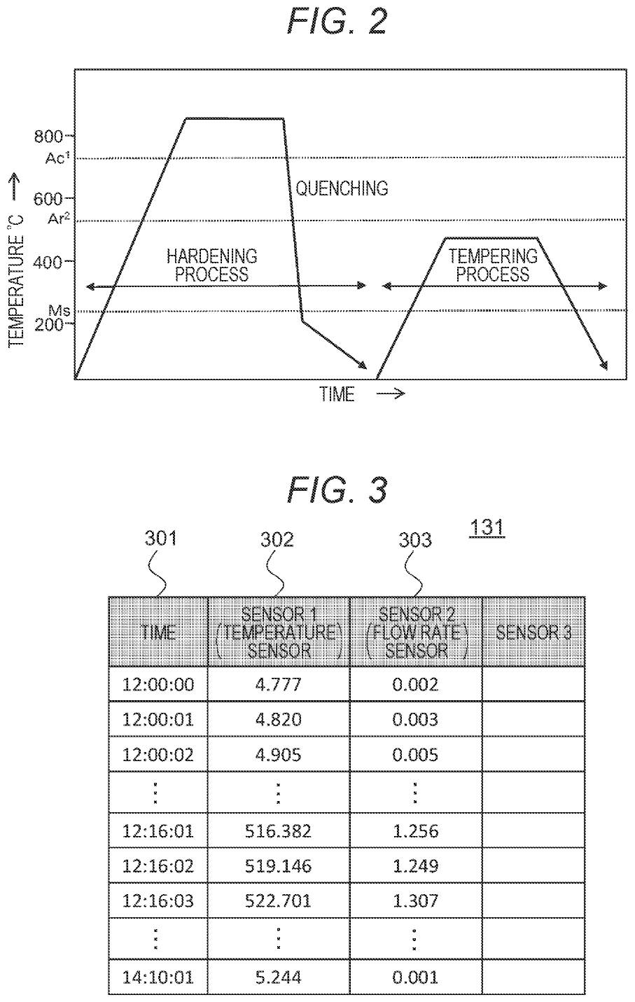

In this embodiment, for example, a metalworking manufacturer's system that heats and processes steel material in a high-temperature furnace is taken up as a monitored system. In this system, as in an example of temperature change illustrated in FIG. 2, there are processing recipes corresponding to types of the steel material (different preparation method and procedure manual for different product types). Thus, temperatures at the time of heating, during the process of cooling, and at the time of heat retention are different.

In the metalworking system described above, when analyzing metalworking fuel efficiency, it is necessary to monitor fuel usage (basic unit: fuel [L]/steel amount [ton]) in each production lot. Here, examples of a change factor to be detected include:

(1) deterioration of an inner wall of the furnace and a drop of a heat retention capacity of the furnace, leading to fuel consumption; and

(2) opening and closing a door of the furnace during processing in order to check the inside of the furnace, causing a control system to consume extra fuel to prevent a temperature drop.

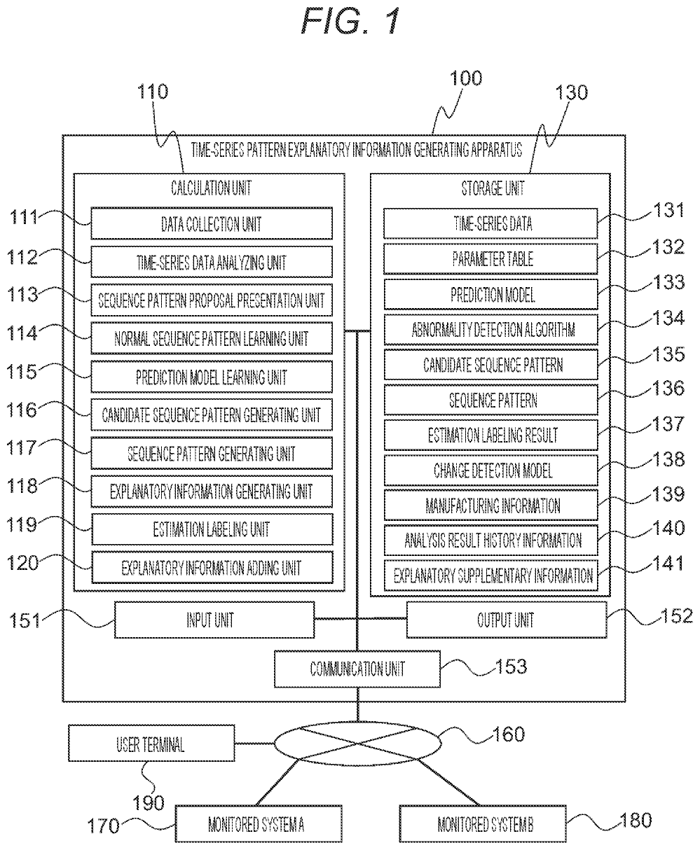

FIG. 1 is a configuration diagram of a time-series pattern explanatory information generating apparatus according to this embodiment.

The time-series pattern explanatory information generating apparatus 100 can be configured on a general-purpose computer. A hardware configuration thereof includes a calculation unit 110 including a central processing unit (CPU) and a random access memory (RAM), a storage unit 130 including a read only memory (ROM), a hard disk drive (HDD), and a solid state drive (SSD) using a flash memory or the like, an input unit 151 including an input device such as a keyboard and a mouse, an output unit 152 including a display device such as a liquid crystal display (LCD) and an organic EL display and various output devices, and a communication unit 153 including a network interface card (NIC).

The communication unit 153 is connected to a monitored system A 170, a monitored system B 180, and a plurality of user terminals 190 via a network 160.

The CPU executes a time-series pattern analysis processing program (not illustrated) that is stored in the storage unit 130 and is loaded into the RAM, so that the calculation unit 110 implements following functional units.

The calculation unit 110 includes a data collection unit 111, a time-series data analyzing unit 112, a sequence pattern proposal presentation unit 113, a normal sequence pattern learning unit 114, a prediction model learning unit 115, a candidate sequence pattern generating unit 116, a sequence pattern generating unit 117, an explanatory information generating unit 118, an estimation labeling unit 119, and an explanatory information adding unit 120.

The storage unit 130 includes time-series data 131, a parameter table 132, a prediction model 133, an abnormality detection algorithm 134, a candidate sequence pattern 135, a sequence pattern 136, an estimation labeling result 137, a change detection model 138, manufacturing information 139, analysis result history information 140, and explanatory supplementary information 141.

Assuming that, in this embodiment, the monitored system A 170 is the above-described metalworking manufacturer's system that heats and processes steel material in the high-temperature furnace, each functional unit of the calculation unit and each storage area of the storage unit will be described below.

A temperature sensor that detects a temperature in the furnace is installed in the high-temperature furnace of the monitored system A 170, and a flowmeter (flow rate sensor) is installed in a supply path through which fuel is supplied to a heater that raises the temperature in the furnace. In addition, various sensors are installed as necessary for analysis.

### Data Collection Unit 111

The data collection unit 111 collects output of the temperature sensor that measures the temperature in the furnace to be monitored, output of the flow rate sensor that measures a flow rate in the supply path through which fuel is supplied to the heater that heats the inside of the furnace, and the like, for a predetermined period at every predetermined time (for example, every 1 second) in accordance with a request from the metalworking manufacturer that requests analysis. The data collection unit 111 stores time-series data of the sensors for each period in the time-series data 131 of the storage unit 130 as time-series data in a data record format where output values of the sensors are associated with each time as illustrated in FIG. 3. Then, the data collection unit 111 receives manufacturing information (furnace name, steel type, steel amount, manufacturing period, manufacturing time, and the like) separately sent from the metalworking manufacturer, and stores the manufacturing information in the manufacturing information 139 of the storage unit 130 in association with the time-series data 131.

Alternatively, in some cases, the metalworking manufacturer collects the output of the sensors for a predetermined period by itself and requests analysis of the time-series data of the sensors for each period as a whole. In this case, the data collection unit 111 receives the time-series data and the manufacturing information, and stores the time-series data and the manufacturing information in the time-series data 131 and the manufacturing information 139, respectively.

In time-series data analysis processing, local sequence data indicating a characteristic change having a high appearance probability is extracted from the time-series data. Then, a plurality of pieces of local sequence data is classified on the basis of similarity, and a sequence pattern is generated from a representative piece of local sequence data in each classification.

### Sequence Pattern Generating Unit 117

The sequence pattern generating unit 117 inputs time-series data to be processed to activate the prediction model learning unit 115 in order to first train a prediction model.

### Prediction Model Learning Unit 115

The prediction model learning unit 115 constructs a prediction model f of the time-series data by a neural network. The outline of the prediction model is as follows.

Let:

output (prediction result) of the prediction model f of the time-series data be y\hat{ }=f(x);

a prediction source be a subsequence x(t)={d_((2t−Wᵢₙ+1)/2), . . . , d_t, . . . , d_((2t+Wᵢₙ−1)/2)} with a window width Wᵢₙ;

a prediction target be a subsequence y(t)=x(t+W)={d_((2t+2W−Wₒᵤₜ+1)/2), . . . , d_(t+W), . . . , d_((2t+2W+Wₒᵤₜ−1)/2)} with a window width Wₒᵤₜ; and

a learning loss function serving as a prediction error be a sum of squared errors E=1/2Σ[(y\hat{ }−y)]\hat{ }2.

Here, d_t represents time-series data at time t. The window width Wᵢₙ and the window width Wₒᵤₜ are both odd and may be the same value. W represents a time-series data interval between the center of a prediction source window and the center of a prediction target window, W=(Wᵢₙ+Wₒᵤₜ)/2.

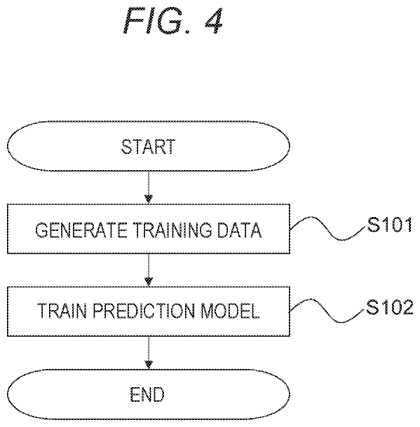

FIG. 4 is a flowchart illustrating an example of prediction model f learning processing executed by the prediction model learning unit 115.

In step S101, as training data, combinations of the prediction source subsequence x(t) with the window width Win and the prediction target subsequence y(t)=x(t+W) with the window width Wₒᵤₜ are generated from the time-series data to be processed, by shifting the prediction source subsequence x(t) and the prediction target subsequence y(t) by a freely-selected width from the head to the end of the time-series data.

In step S102, training for adjusting a parameter of the prediction model f is repeated so that the error of the loss function approaches 0, on the basis of the combinations as the training data generated in S101 and the output y\hat{ }=f(x) of the prediction model f.

In this embodiment, for example, the prediction model f is a fully connected neural network having a three-layer network structure, and uses ReLU as an activation function, adam as a gradient method, and a sum of squared errors as the loss function. In the learning processing, for example, a process of directly learning all the time-series data to be processed is repeated about 100 times.

The prediction model learning unit 115 updates the prediction model f stored in the prediction model 133 of the storage unit 130 every time the prediction model f learning processing is executed using one piece of training data.

### Candidate Sequence Pattern Generating Unit 116

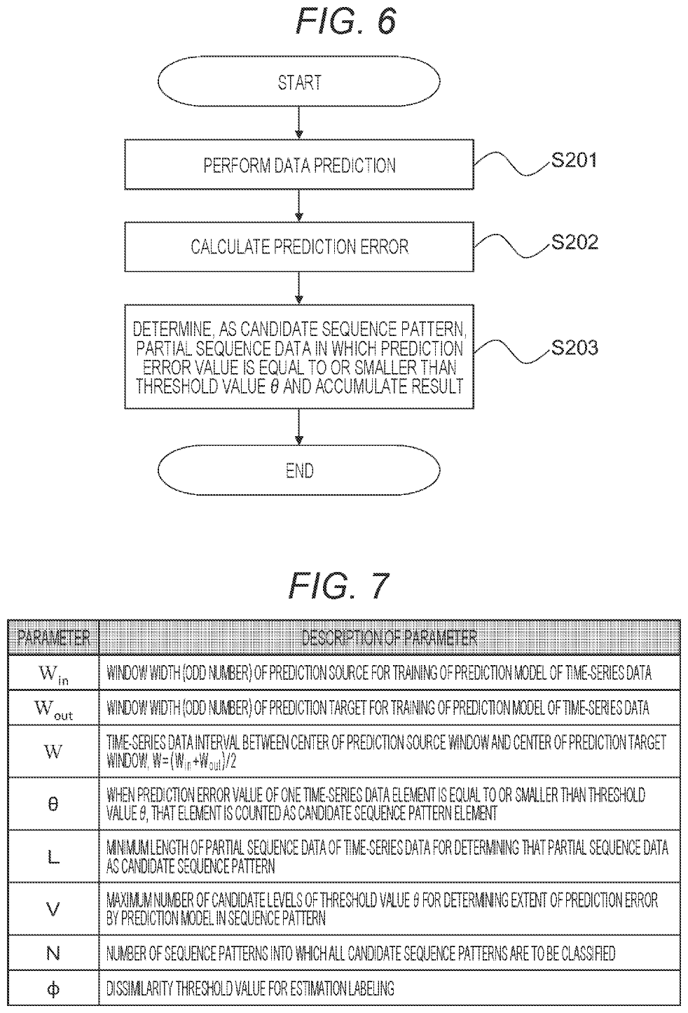

The sequence pattern generating unit 117 activates the candidate sequence pattern generating unit 116 after completion of the learning processing in the prediction model learning unit 115. FIG. 6 illustrates a flowchart of candidate sequence pattern extraction processing by the candidate sequence pattern generating unit 116.

The candidate sequence pattern generating unit 116 extracts local sequence data indicating a characteristic change having a high appearance probability from time-series data to be processed. The candidate sequence pattern generating unit 116 sequentially reads the time-series data to be processed from the head from the time-series data 131, creates a prediction source subsequence x(t) with the window width Wᵢₙ, and inputs the created prediction source subsequence x(t) to the prediction model f stored in the prediction model 133. A prediction result y\hat{ }=f(x) is output using the prediction model f (step S201). Then, the candidate sequence pattern generating unit 116 calculates, as a prediction error of a time-series data element at the time (t+W), the absolute value of a difference between a central element value of the window width Wₒᵤₜ of the prediction result and a central element value d_(t+W) of a prediction target subsequence y(t) with the window width Wₒᵤₜ (step S202). While the prediction source subsequence x(t) to be created on the time-series data is sequentially shifted by one element, the prediction error is calculated for up to the end element of the time-series data.

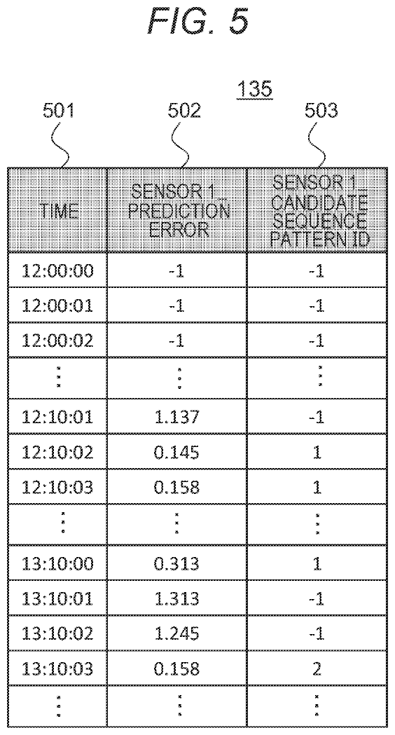

FIG. 5 illustrates an intermediate data table for generating candidate sequence patterns. The intermediate table is stored in the candidate sequence pattern 135 of the storage unit 130.

Data in a sensor 1_prediction error field 502 of the data table for candidate sequence patterns in FIG. 5 is obtained by, for example, reading time-series data in a sensor 1 (temperature sensor) field 302 in FIG. 3, executing the above-described prediction error calculation process in the candidate sequence pattern generating unit 116 for all the time-series data (step S202), and storing calculated prediction errors in record positions such that time 301 in FIG. 3 corresponds to time 601 in FIG. 5. Note that “−1” is entered in the prediction error field because there are no central elements of the window width Wₒᵤₜ between the time 12:00:00 and 12:00:02 and, thus, the calculation fails.

Subsequently, the candidate sequence pattern generating unit 116 sequentially reads the data in the sensor 1_prediction error field 502 of the data table in FIG. 5 from the head. When L or more consecutive elements have a prediction error value equal to or smaller than a threshold value θ, the candidate sequence pattern generating unit 116 determines partial sequence data of the time-series data corresponding to the consecutive elements as a candidate sequence pattern. The candidate sequence pattern generating unit 116 records at least one candidate sequence pattern ID (different numbers are assigned for different candidate sequence patterns) in record positions corresponding to the elements having a prediction error value equal to or smaller than the threshold value θ in a sensor 1_candidate sequence pattern ID field 503 (step S203).

When the number of consecutive elements having a prediction error value equal to or smaller than the threshold value θ is smaller than L, or when the prediction error field has “−1” due to a calculation failure, or when the prediction error value exceeds the threshold value θ, “−1” is recorded in a corresponding record position in the sensor 1_candidate sequence pattern ID field 503.

The data in the sensor 1_candidate sequence pattern ID field 503 in FIG. 5 indicates that partial sequence data of elements between the time 12:10:02 and 13:10:00 is a candidate sequence pattern to which a candidate sequence pattern ID=1 is assigned, and partial sequence data of consecutive elements after the time 13:10:03 is a candidate sequence pattern to which a candidate sequence pattern ID=2 is assigned.

### Parameter Table 132

FIG. 7 illustrates a table summarizing parameters used in the functional units of this embodiment and descriptions thereof. An initial value of each parameter is set in advance in the parameter table 132 of the storage unit 130 by an administrator of the time-series pattern explanatory information generating apparatus 100.

When a parameter value is set by the user to be calculated in the functional units, the parameter value stored in the parameter table 132 is updated.

### Sequence Pattern Generation Processing

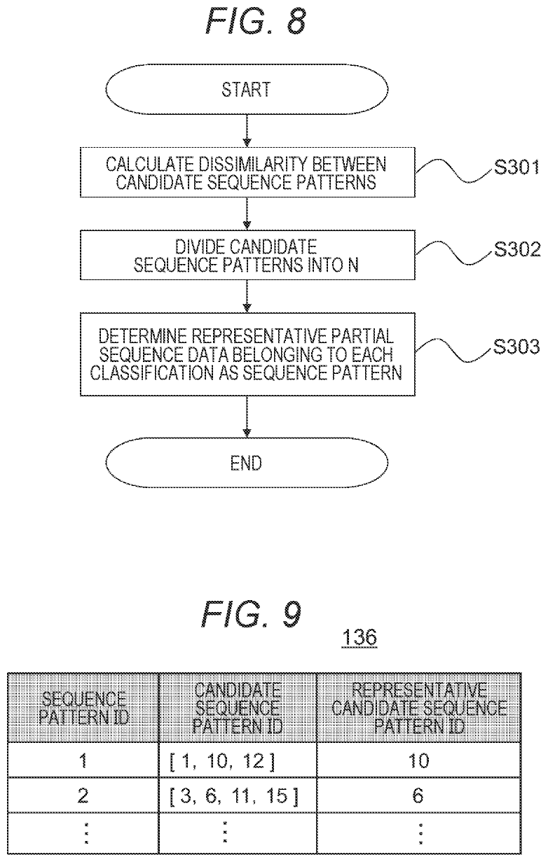

After completion of the processing in the candidate sequence pattern generating unit 116, the sequence pattern generating unit 117 executes sequence pattern generation processing whose flowchart is illustrated in FIG. 8.

In step S301, a mutual dissimilarity is calculated for all candidate sequence patterns (partial sequence data of the time-series data) to which the candidate sequence pattern IDs are assigned by the candidate sequence pattern generating unit 116. Although dynamic time warping (DTW) is used to calculate the dissimilarity, another distance calculation method such as D-DTW may be used.

In step S302, all the candidate sequence patterns are divided into N clusters using hierarchical clustering.

In step S303, when compared by a data length, a piece of partial sequence data having the median data length is set as a representative among pieces of partial sequence data belonging to each cluster. In the representative determination, a piece of partial sequence data having the shortest or longest data length may be set as a sequence pattern.

In a case where the number of candidate sequence patterns belonging to a cluster after the division into N is small (for example, in a case where there is only one), the representative sequence pattern determination may be performed in disregard of that cluster (patterns are considered to be presented for less than N clusters).

The sequence pattern generating unit 117 divides all the candidate sequence patterns into N clusters, determines a representative sequence pattern for each cluster, and assigns at least one individual sequence pattern ID to a sequence pattern of each cluster through the sequence pattern generation processing.

FIG. 9 shows a data table in which a sequence pattern ID, a candidate sequence pattern ID, and a representative candidate sequence pattern ID are associated with each other for management. For example, a sequence pattern ID=1, candidate sequence pattern IDs=1, 10, and 12, and a representative candidate sequence pattern ID=10 are associated with each other. The sequence pattern generating unit 117 stores the data table in the sequence pattern 136 of the storage unit 130.

### Estimation Labeling Unit 119

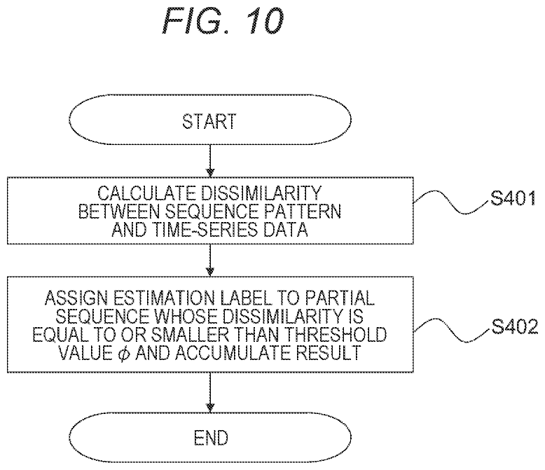

The estimation labeling unit 119 executes processing of estimating where a designated sequence pattern is located on time-series data to be processed according to the flowchart illustrated in FIG. 10.

In step S401, the estimation labeling unit 119 calculates, for example, using DTW, a dissimilarity between the sequence pattern and partial sequence data of the time-series data from the head with a predetermined window width (the same length as the sequence pattern, or a predetermined expansion/contraction width). The dissimilarity calculation is repeated while the partial sequence data of the time-series data is sequentially shifted by one element toward the end of the time-series data.

In step S402, an estimation label is assigned to a central element of the window width of partial sequence data whose dissimilarity calculated in S401 is equal to or smaller than a threshold value φ, and a result thereof is accumulated.

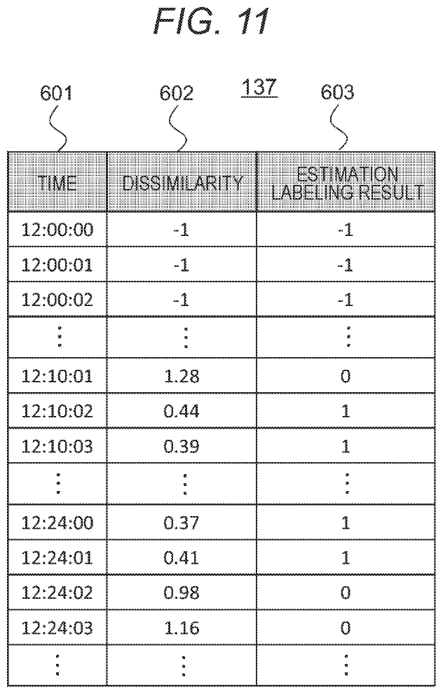

That is, in an example of an output data table of an estimation labeling result illustrated in FIG. 11, a dissimilarity (602) at the time (601) 12:10:01 is 1.28, which exceeds the threshold value φ and is thus considered as not applicable, so that 0 is set to an estimation labeling result (603). All dissimilarities of elements between the time 12:10:02 and 12:24:01 are equal to or smaller than the threshold value φ and are thus considered as applicable, so that 1 is set to the estimation labeling result. All dissimilarities of elements between the time 12:24:02 and 12:24:03 exceed the threshold value φ and are thus considered as not applicable, so that 0 is set to the estimation labeling result. Note that there are no central elements of the window width between the time 12:00:00 and 12:00:02, and the calculation is thus fails, so that −1 meaning not applicable is set.

The estimation labeling unit 119 stores the created output data table of the estimation labeling result in the estimation labeling result 137 of the storage unit 130.

### Sequence Pattern Proposal Presentation Unit 113

The sequence pattern proposal presentation unit 113 receives, from a user who requests analysis of time-series data (metalworking manufacturer in this embodiment), a time-series data analysis request and designation input, and is then activated. The designation input designates the maximum number V of candidate levels of the threshold value θ for determining an extent of a prediction error by the prediction model in a sequence pattern, and the number N of sequence patterns into which all candidate sequence patterns are to be classified, in order to extract a characteristic sequence pattern included in the time-series data and having a high appearance probability.

The sequence pattern proposal presentation unit 113 stores both the parameters (maximum number V of candidate levels of the threshold value θ and number N of sequence patterns) received from the user in the parameter table 132 of the storage unit 130.

Subsequently, the prediction model learning unit 115 is activated to train the prediction model f.

The sequence pattern proposal presentation unit 113 uses the prediction model f to calculate a prediction error of each element of the time-series data, for example. Then, the sequence pattern proposal presentation unit 113 (for example, using a k-means method) clusters all prediction errors into V+1 clusters, where V is the maximum number of candidate levels of the threshold value θ, and sets boundary values of the clusters as θ₁, . . . , θ_{V}. The calculated V threshold values θ₁, . . . , θ_{V} are stored in the parameter table 132.

The sequence pattern proposal presentation unit 113 individually selects the V threshold values θ₁, . . . , θ_{V} to execute, using each threshold value, the processing in the candidate sequence pattern generating unit 116 and the sequence pattern generation processing in the sequence pattern generating unit 117. Then, N sequence patterns are generated for each threshold value (classified sequence pattern group generated for each threshold value θ₁, . . . , θ_{V} is referred to as sequence pattern proposal 1 to V).

The sequence pattern proposal presentation unit 113 presents, to the user via a user terminal 190, the N sequence patterns for each of V types of generated sequence pattern proposals in a form of, for example, a list of graphical representations of all the sequence patterns included in any of the sequence pattern proposals, or a list of graphical representations of representative sequence patterns included in all the sequence pattern proposals, in accordance with a request from the user. The user examines the presented list of graphical representations of sequence patterns, and selects and designates a sequence pattern proposal and a sequence pattern to be adopted for subsequent processing.

FIG. 15 shows an image diagram illustrating time-series data input to the sequence pattern proposal presentation unit 113, parameters (maximum number V of candidate levels of the threshold value θ and number N of sequence patterns), and sequence pattern proposals (case of V=4) and sequence patterns (case of N=3) to be output.

### Normal Sequence Pattern Learning Unit 114

Prior to the time-series data analysis request, the user (metalworking manufacturer in this embodiment) may transmit, together with manufacturing information, time-series data collected during normal operation of the monitored system, with an identification flag of “normal time” attached thereto. When receiving such time-series data, the normal sequence pattern learning unit 114 is activated.

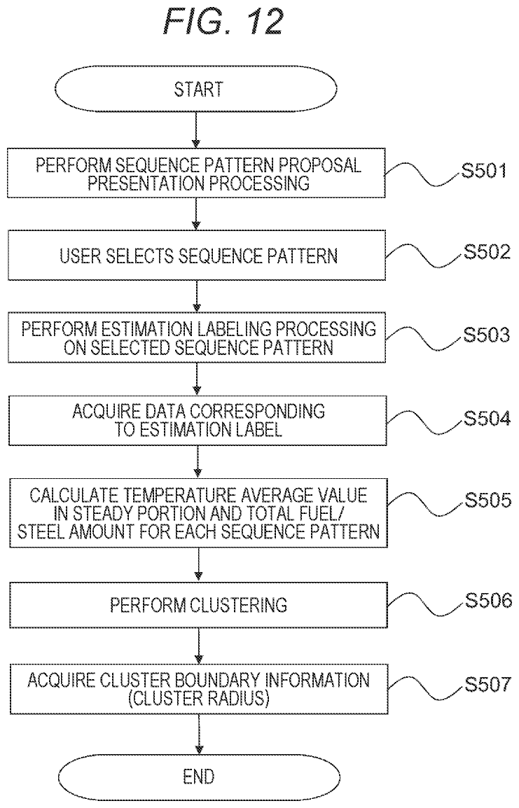

FIG. 12 illustrates a flowchart of processing in the normal sequence pattern learning unit 114.

In step S501, the sequence pattern proposal presentation unit 113 receives the maximum number V of candidate levels of the threshold value θ and the number N of sequence patterns from the user, and generates N sequence patterns for each threshold value (referred to as a sequence pattern proposal 1 to V for each threshold value θ₁, . . . , θ_{V}) from time-series data received from the user. Graphs of all the sequence patterns included in each sequence pattern proposal are presented to the user via the user terminal 190.

In step S502, the user examines a presented list of graphical representations of sequence patterns included in all the sequence pattern proposals, and selects and designates an appropriate sequence pattern as a normal-time sequence pattern.

In step S503, the estimation labeling unit 119 performs the processing of estimating where each normal-time sequence pattern (a plurality of types of sequence patterns may be selected depending on the steel type, the steel amount, and the like) selected and designated by the user is located on the normal-time time-series data to be processed, and stores an estimation label assignment result in the estimation labeling result 137.

In step S504, partial sequence data of the normal-time time-series data to be processed to which 1 is assigned as the estimation labeling result in S503 is acquired. A plurality of pieces of partial sequence data may be acquired. A start time, an end time, and the like of the acquired partial sequence data are compared with a start time, an end time, and the like in the manufacturing information to acquire a corresponding piece of the manufacturing information (furnace name, steel type, steel amount, manufacturing period, manufacturing time, and the like).

In step S505, (1) a temperature average value in a steady portion is calculated for partial sequence data (sequence pattern) of time-series data of the temperature sensor, and (2) a total fuel/steel amount is calculated for partial sequence data (sequence pattern) of time-series data of the fuel flow rate sensor.

In step S506, a normal-time combination of ((1) the temperature average value in a steady portion of a sequence pattern, (2) the total fuel/steel amount of a sequence pattern) that are calculated in S505 and are associated with the same piece of the manufacturing information is plotted on a coordinate system in which the horizontal axis represents the temperature and the vertical axis represents the total fuel/steel amount. Then, plotted points are clustered by a steel type.

In step S507, a cluster center and a cluster radius are calculated for each steel type cluster of the normal-time plotted points of (feature of a sequence pattern of time-series data of the temperature sensor, feature of a sequence pattern of time-series data of the fuel flow rate sensor) created in S506, and the cluster information is stored in the change detection model 138 of the storage unit 130.

### Time-Series Data Analyzing Unit 112

After the user (metalworking manufacturer in this embodiment) issues instructions on an analysis request for time-series data from its own monitored system, and the data collection unit 111 acquires user-designated time-series data to be processed and manufacturing information, the time-series data analyzing unit 112 is activated.

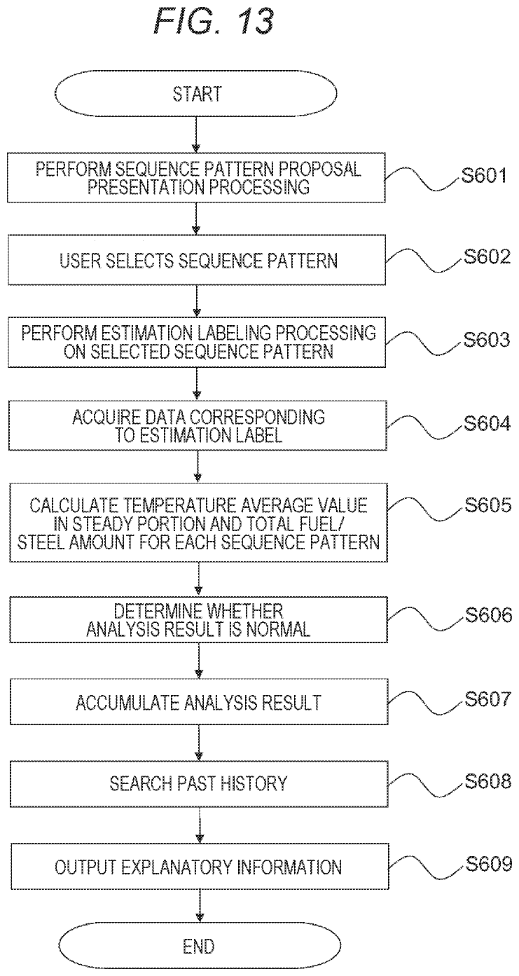

FIG. 13 illustrates a flowchart of processing in the time-series data analyzing unit 112.

In step S601, the sequence pattern proposal presentation unit 113 receives the maximum number V of candidate levels of the threshold value θ and the number N of sequence patterns from the user, and generates N sequence patterns for each threshold value (referred to as a sequence pattern proposal 1 to V for each threshold value θ₁, . . . , θ_{V}) from the time-series data received from the user. Graphs of all the sequence patterns included in each sequence pattern proposal are presented to the user via the user terminal 190.

In step S602, the user examines a presented list of graphical representations of sequence patterns included in all the sequence pattern proposals, and selects and designates an appropriate sequence pattern to be analyzed.

In step S603, the estimation labeling unit 119 executes the processing of estimating where each sequence pattern to be analyzed (a plurality of types of sequence patterns may be selected depending on the steel type, the steel amount, and the like) selected and designated by the user is located on the time-series data to be analyzed, and stores an estimation label assignment result in the estimation labeling result 137.

In step S604, partial sequence data of the time-series data to be analyzed to which 1 is assigned as the estimation labeling result in S603 is acquired. A plurality of pieces of partial sequence data may be acquired. A start time, an end time, and the like of the acquired partial sequence data are compared with a start time, an end time, and the like in the manufacturing information to acquire a corresponding piece of the manufacturing information (furnace name, steel type, steel amount, manufacturing period, manufacturing time, and the like).

In step S605, (1) a temperature average in a steady portion is calculated for partial sequence data (sequence pattern) of time-series data of the temperature sensor, and (2) a total fuel/steel amount is calculated for partial sequence data (sequence pattern) of time-series data of the fuel flow rate sensor.

In step S606, an analysis target combination of ((1) the temperature average value in a steady portion of a sequence pattern, (2) the total fuel/steel amount of a sequence pattern) that are calculated in S605 and are associated with the same piece of the manufacturing information is plotted on a coordinate system in which the horizontal axis represents the temperature and the vertical axis represents the total fuel/steel amount. Then, the cluster information of the same steel type is read from the normal-time change detection model 138, and the distance from the cluster center to the plotted point is compared with the cluster radius.

According to the abnormality detection algorithm 134 introduced in advance, when the distance from the cluster center to the plotted point is equal to or smaller than the cluster radius, “normal” is determined, and when the distance exceeds the cluster radius, “abnormal” is determined. As an analysis result, for example, determination information on whether the total fuel/steel amount is larger or smaller than a normal-time average value is stored.

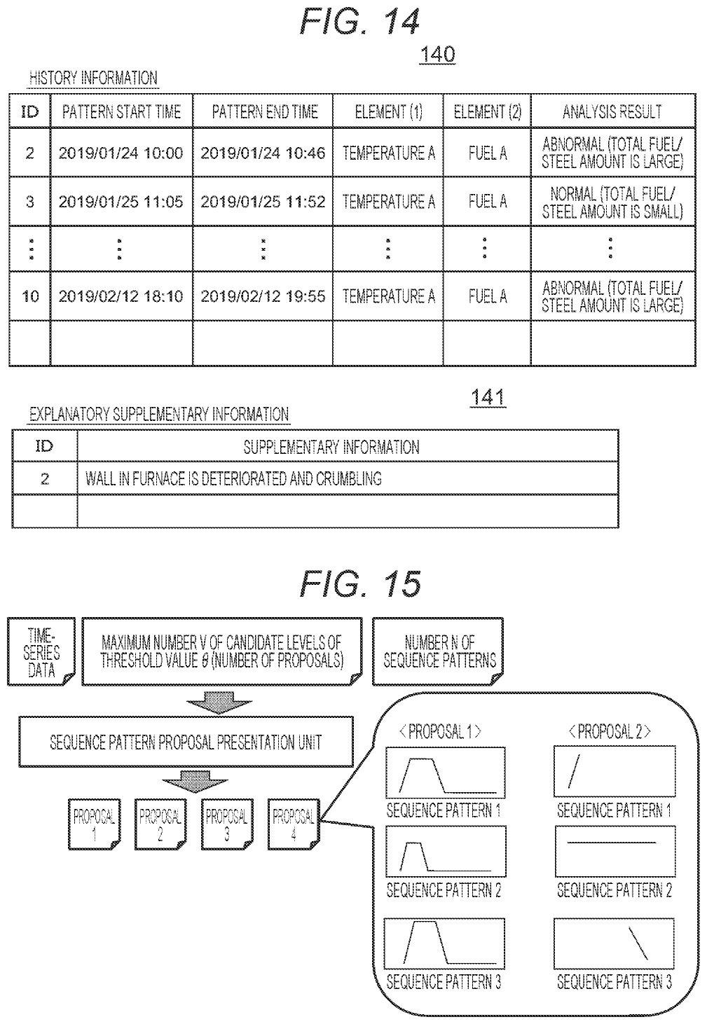

In step S607, the analysis result determined in S606 is stored in the analysis result history information 140 of the storage unit 130. In an analysis result history information data table (see FIG. 14), an ID is assigned to the analysis result, and data items such as a pattern start time, a pattern end time, the type of sensor to be analyzed: element (1); element (2), and the analysis result are stored.

In step S608, a past history data record that is stored in the analysis result history information 140 and matches the current analysis result in the element (1) item, the element (2) item, and the analysis result item is searched for. When an ID of the matching past history information is associated with a piece of supplementary information formerly recorded by the user, the piece of the supplementary information is searched for.

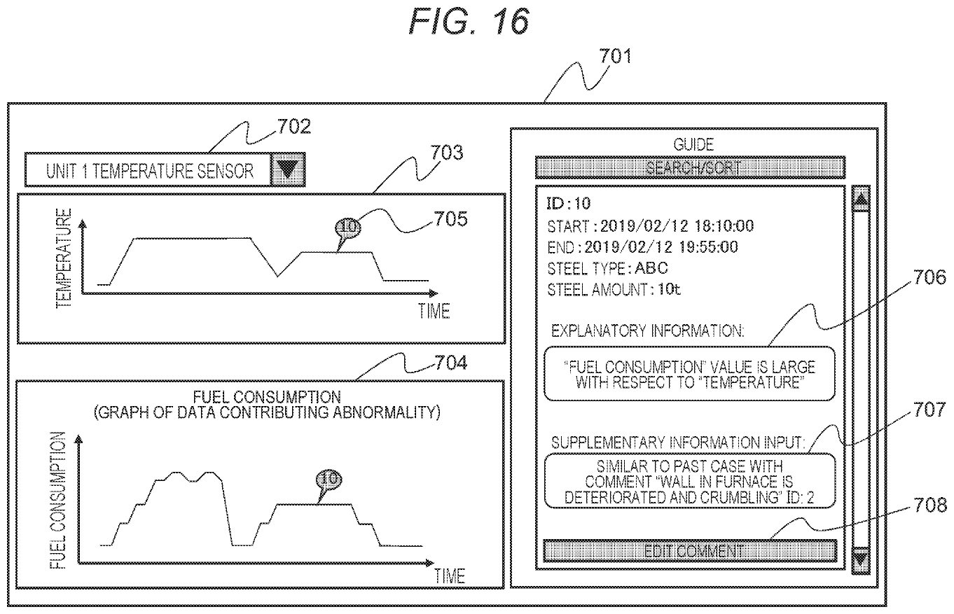

In step S609, the explanatory information generating unit 118 outputs explanatory information illustrated in FIG. 16 to the user terminal 190 on the basis of the analysis result and the past history search.

An explanatory information display screen 701 of FIG. 16 displays a display frame 702 for designating a facility (sensor) of the time-series data to be analyzed this time, a graph 703 of a designated sequence pattern of the temperature sensor, and a graph 704 of a sequence pattern of fuel consumption (time-series data output from the fuel flow rate sensor) as data contributing to abnormality. The graph of each sequence pattern includes a current analysis result ID 705.

In an explanatory information field 706, explanatory information of the analysis result determined in S606 is displayed.

When the current analysis result matches the past history data record in the element (1) item, the element (2) item, and the analysis result item in S608, when the ID of the matching analysis result history information 140 is associated with a piece of the explanatory supplementary information 141 (see FIG. 14) formerly recorded by the user, the piece of the explanatory supplementary information is displayed in a supplementary information field 707.

The user checks an abnormal state of the monitored system by viewing the explanatory information display screen 701 displayed on the user terminal 190, and can record a matter noticed about the state of the monitored system as a comment.

When the user inputs any comment in the supplementary information input field 707 and presses a comment edit button 708, the explanatory information adding unit 120 assigns the current ID of the history information to the input comment and records the input comment in the explanatory supplementary information 141 (see FIG. 14).

### Reference Signs List

100 time-series pattern explanatory information generating apparatus
110 calculation unit
111 data collection unit
112 time-series data analyzing unit
113 sequence pattern proposal presentation unit
114 normal sequence pattern learning unit
115 prediction model learning unit
116 candidate sequence pattern generating unit
117 sequence pattern generating unit
118 explanatory information generating unit
119 estimation labeling unit
120 explanatory information adding unit
130 storage unit
131 time-series data
132 parameter table
133 prediction model
134 abnormality detection algorithm
135 candidate sequence pattern
136 sequence pattern
137 estimation labeling result
138 change detection model
139 manufacturing information
140 analysis result history information
141 explanatory supplementary information
151 input unit
152 output unit
153 communication unit
160 network
170 monitored system A
180 monitored system B
190 user terminal
701 explanatory information display screen
702 display frame for designating a facility (sensor)
703 graph of a designated sequence pattern of a temperature sensor
704 graph of a sequence pattern of fuel consumption
705 current analysis result ID
706 explanatory information field
707 supplementary information field
708 comment edit button

1. A time-series pattern explanatory information generating apparatus comprising:
a prediction model learning unit configured to, when time-series data acquired from a monitored system is input, learn the time-series data in a neural network to construct a prediction model;
a candidate sequence pattern generating unit configured to use the prediction model to extract candidate sequence patterns each of which is local sequence data included in the time-series data, the local sequence data indicating a characteristic change having a high appearance probability;
a sequence pattern generating unit configured to calculate a dissimilarity among the extracted candidate sequence patterns to classify the extracted candidate sequence patterns, and output a representative candidate sequence pattern included in each classification as a sequence pattern of the time-series data; and
a time-series data analyzing unit configured to designate a sequence pattern that is freely selected from sequence patterns extracted from time-series data obtained from the monitored system, calculate a feature from the designated sequence pattern, draw a comparison with a change detection model storing a feature calculated, in advance, from a normal-time sequence pattern, and output an analysis result as to whether the monitored system is normal.

2. The time-series pattern explanatory information generating apparatus according to claim 1, wherein
the prediction model learning unit generates, as training data, combinations of a prediction source subsequence x(t) with a window width Wᵢₙ and a prediction target subsequence y(t)=x(t+W) with a window width Wₒᵤₜ from the time-series data, by shifting the prediction source subsequence x(t) and the prediction target subsequence y(t) by a freely-selected width from a head to an end of the time-series data, and
the prediction model learning unit repeats training for adjusting a parameter of the prediction model f so that an error of a loss function approaches 0, based on the generated combinations as the training data and output y\hat{ }=f(x) of the prediction model f.

3. The time-series pattern explanatory information generating apparatus according to claim 1, wherein
the candidate sequence pattern generating unit sets a predetermined number or more consecutive elements of the time-series data as the candidate time-series pattern, each of the consecutive elements having a prediction error between a result of prediction using the prediction model and the time-series data, the prediction error being equal to or smaller than a predetermined threshold value θ.

4. The time-series pattern explanatory information generating apparatus according to claim 1, further comprising a sequence pattern proposal presentation unit configured to receive, from a user who requests analysis of time-series data of the monitored system, designation of a maximum number V of candidate levels of a threshold value θ and designation of a number N of sequence patterns into which all candidate sequence patterns are to be classified, and configured to calculate V threshold values θ₁, . . . θ_{V} from the time-series data, calculate V×N sequence patterns, and present the calculated sequence patterns to the user, in accordance with a request from the user.

5. The time-series pattern explanatory information generating apparatus according to claim 1, further comprising a normal sequence pattern learning unit configured to:
when time-series data collected during normal operation of the monitored system is input, calculate sequence patterns from the time-series data, and calculate features from the sequence patterns; and
cluster the features by a product type, and store information of each cluster as the change detection model.

6. The time-series pattern explanatory information generating apparatus according to claim 1, wherein
the time-series data analyzing unit calculates a feature from a sequence pattern extracted from time-series data to be analyzed, draw a comparison with the change detection model, and determine whether the monitored system is normal,
the time-series pattern explanatory information generating apparatus further comprising an explanatory information generating unit configured to, when the monitored system is determined to be abnormal, search a past history to read a piece of supplementary information formerly recorded by a user, and display, on an explanatory information display screen, a graph of data contributing to abnormality, explanatory information of an analysis result, and the piece of the supplementary information.

7. The time-series pattern explanatory information generating apparatus according to claim 6, further comprising an explanatory information adding unit configured to receive, from the explanatory information display screen, information of a matter noticed and input as a comment by the user about a state of the monitored system determined to be abnormal, and record the information as the supplementary information.
